(19) United States
(12) Patent Application Publication
(10) Pub. No.: US 2005/0152137 A1
(43) Pub. Date: Jul. 14, 2005

(54) LED flashlight

(75) Inventor: Rainer Opolka, Solingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: ZWEIBRUDER OPTOELECTRONICS GMBH

(21) Appl. No.: 11/020,019

(22) Filed: Dec. 21, 2004

(30) Foreign Application Priority Data
Jan. 8, 2004 (DE) 202004000225.6

(51) Int. Cl. F21L 4/02

(52) U.S. Cl. 362/184; 362/191; 362/200

(57) ABSTRACT

A flashlight has a generally cylindrical housing centered on an axis, adapted to hold a battery, having a pair of opposite ends, and formed between the ends with a radially open aperture. A light-emitting diode in the housing is aligned behind the aperture to emit a light beam radially through the aperture. A switch in the housing is operable to connect the diode to a battery in the housing and thereby project a light beam radially of the housing through the aperture. A clip is provided on the housing between the ends thereof. The switch is at one of the ends of the housing and includes an axially shiftable pushbutton centered on the axis.

### FIELD OF THE INVENTION

The present invention relates to a flashlight.

### BACKGROUND OF THE INVENTION

It is known to replace the traditional incandescent bulb of a flashlight with a light-emitting diode (LED). This produces several advantages. The flashlight can be made much smaller because of the reduced size and power requirements of the LED so that the battery size can also be reduced. In addition the flashlight is much more rugged because of the solid-state light source.

The standard LED flashlight is made much like a standard incandescent-bulb flashlight. There is a cylindrical case or housing centered on an axis dimensioned to snugly contain the battery, typically one or more AA or AAA cells. The LED is provided at one end of the housing behind an opening or lens so as to project light axially. One side is provided with a switch, typically either a radially shiftable pushbutton or an axially movable slide switch, for making and breaking the connection between the LED and the battery. It is also known to provide a flexible stalk at one end of the housing with the LED on its outer end so that, by bending the stalk, the light beam can be directed an acute angle or perpendicularly to the housing axis. A clip is further often provided on one side of the housing to allow it to be held in a pocket or on a belt or, in the case of a stalk-type unit, to be clipped to something to illuminate a particular area.

While such a flashlight is a significant improvement on the old incandescent-bulb model, it has several drawbacks. It cannot be used as a safety beacon for a jogger or biker because, when clipped to the user the light is not going to be directed outward. Use of a flexible-stalk flashlight for a jogger or biker is impractical as the constant motion will quickly misalign or damage the device. Furthermore the switch on such flashlights is often actuated unintentionally. Providing a biaxial-motion system to prevent such unintentional actuation increases the cost of the device and the complexity of operation so is not a viable option for what is frequently a low-cost or disposable piece of equipment.

### OBJECTS OF THE INVENTION

It is therefore an object of the present invention to provide an improved LED flashlight.

Another object in the provision of such an improved LED flashlight that overcomes the above-given disadvantages, in particular that is compact and inexpensive.

A further object is to provided such an LED flashlight that can be used as a beacon for a runner or jogger, and where inadvertent actuation of the on-off switch is unlikely.

### SUMMARY OF THE INVENTION

A flashlight has according to the invention a generally cylindrical housing centered on an axis, adapted to hold a battery, having a pair of opposite ends, and formed between the ends with a radially open aperture. A light-emitting diode in the housing is aligned behind the aperture to emit a light beam radially through the aperture. A switch in the housing is operable to connect the diode to a battery in the housing and thereby project a light beam radially of the housing through the aperture.

Such a lamp can be provided with a clip on the housing between the ends thereof. Thus the lamp can be secured to the clothing of a walker, jogger, or biker, and will emit light directed outward, way from the user. Thus the user will be highly visible in the dark, even if, for example, his or her bicycle is not provided with its own illumination. When according to the invention the clip is diametrally opposite the aperture, the aperture will inherently be oriented to direct light outward, away from the user.

In accordance with the invention the switch is at one of the ends of the housing. This makes it unlikely that it will be actuated accidentally. More particularly, the switch includes an axially shiftable pushbutton centered on the axis. When this pushbutton is recessed slightly, accidental or inadvertent actuation is almost impossible.

According to the invention a radially outwardly concave reflector surrounds the diode inside the housing. Thus all the light emitted by the diode is directed out of the housing.

The diode according to the invention can emit red light so that the flashlight makes a clearly visible beacon.

According to another feature of the invention there are two such diodes in the housing. The housing is formed with two such apertures generally diametrally opposite each other and each of the diodes is aligned with a respective one of the apertures. In addition the two diodes emit light in different colors. Thus one diode can serve as a beacon, and the other can act as a standard flashlight serving to light a path, find a keyhole, or serve any other such standard task.

### BRIEF DESCRIPTION OF THE DRAWING

The above and other objects, features, and advantages will become more readily apparent from the following description, reference being made to the accompanying drawing in which:

FIG. 1 is an axial section through the flashlight according to the invention;

FIG. 2 is a section like FIG. 1 but with the section plane offset 90° to that of FIG. 1; and

FIG. 3 is a sectional detail view of a variant on the flashlight according to the invention.

### SPECIFIC DESCRIPTION

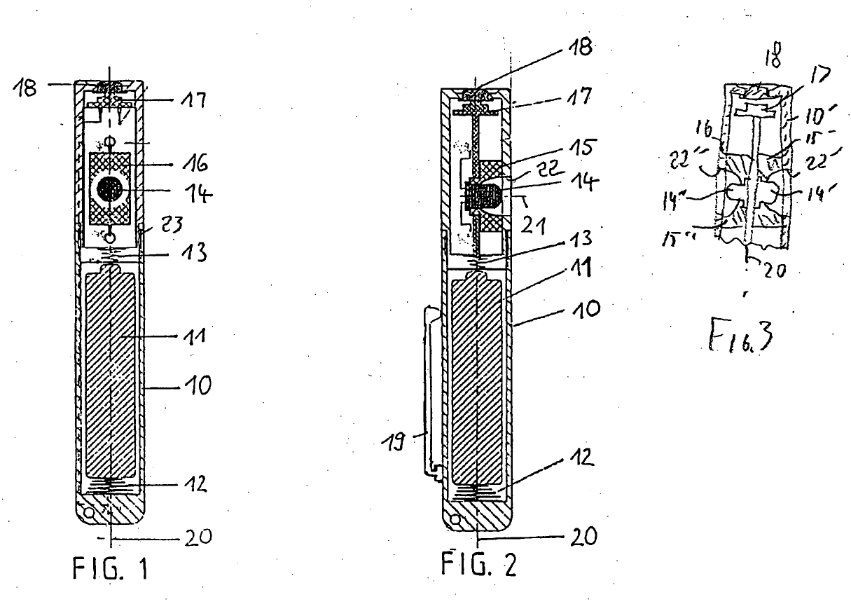

As seen in FIGS. 1 and 2 a generally cylindrical and hollow housing 10 has two parts joined at a central screwthread 23 and is centered on an axis 20. The housing 10 forms a compartment here holding a single battery 11, e.g. an AA cell, whose ends are engaged by spring contacts 12 and 13. Between its ends, the housing 10 is formed with a radially open circular hole or aperture 22 centered on an axis 21 extending radially of the axis 20.

A circuit board 16 inside the housing 10 on its axis 20 carries an LED 14 aligned with the aperture axis 21 so as to emit light, here red light, radially through the aperture 22 along the axis 21. A small concave reflector 15 coaxially surrounds the LED 14 so all its light is directed radially outward.

At one end, the housing 10 is provided with a switch 17 having an axially depressible button 18 forming part of on/off switch means. Each actuation of the button 18 trips the switch 17 to move the circuitry on the board 16 between an on position energizing the LED 14 and an off position. In the on position the LED 14 can blink.

Diametrally opposite the aperture 22 is a clip 19. Thus the flashlight according to the invention can be used as a runner's or biker's beacon. It is clipped to the user, normally to a pocket or belt, so that the aperture 22 is directed outward, away from the user. Then the button 18 is pushed to energize the LED 14, normally by making it blink on and off.

FIG. 3 shows an arrangement wherein the housing 10′ is formed with two diametrally opposite apertures 22′ and 22″ each associated with a respective diode 14′ or 14″ and reflector 15′ or 15″. The diode 14′ emits red light and the diode 14″ white light, and the switch 17′ is set so that, starting from an off position, one depression causes the red LED 14′ to blink, another depression cuts off the LED 14′ and causes the LED 14″ to come on and emit continuous white light, and a third actuation returns the system to the off position in which no light is emitted. Thus this device can be used not only as a safety beacon, but also as a mall standard flashlight.

1. A flashlight comprising:
a generally cylindrical housing centered on an axis, adapted to hold a battery, having a pair of opposite ends, and formed between the ends with a radially open aperture;
a light-emitting diode in the housing behind the aperture aligned to emit a light beam radially through the aperture;
switch means in the housing operable to connect the diode to a battery in the housing and thereby project a light beam radially of the housing through the aperture.

2. The flashlight defined in claim 1, further comprising
a clip on the housing between the ends thereof.

3. The flashlight defined in claim 2 wherein the clip is diametrally opposite the aperture.

4. The flashlight defined in claim 1 wherein the switch means is at one of the ends of the housing.

5. The flashlight defined in claim 3 wherein the switch means includes an axially shiftable pushbutton centered on the axis.

6. The flashlight defined in claim 1, further comprising
a radially outwardly concave reflector surrounding the diode inside the housing.

7. The flashlight defined in claim 1 wherein the diode emits red light.

8. The flashlight defined in claim 1 wherein there are two such diodes in the housing.

9. The flashlight defined in claim 8 wherein the housing is formed with two such apertures generally diametrally opposite each other and each of the diodes is aligned with a respective one of the apertures.

10. The flashlight defined in claim 8 wherein the two diodes emit light in different colors.

11. The flashlight defined in claim 1, further comprising
circuit means in the housing between the switch means and the diode for making the diode blink when the switch means is in an on position.
